(19) United States
(12) Patent Application Publication
(10) Pub. No.: US 2008/0243702 A1
(43) Pub. Date: Oct. 2, 2008

(54) Tokens Usable in Value-Based Transactions

(75) Inventors: Peter E. Hart, Menlo Park, CA (US); John W. Barrus, Menlo Park, CA (US); Jamey Graham, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ricoh Company, Ltd., Tokyo (JP)

(21) Appl. No.: 11/694,076

(22) Filed: Mar. 30, 2007

(51) Int. Cl. H04L 9/00

(52) U.S. Cl. 705/66; 705/69

(57) ABSTRACT

Techniques for generating a token that can be used to transfer value. The token may be used to transfer value in a value-based transaction with a vendor in a way that is secure and safe and maintains anonymity of the source of the value and preserves secrecy of information that should preferably not be disclosed to an untrusted third party such as a vendor. The token comprises sufficient information that enables value to be transferred from an account associated with the token to a vendor during a value-based transaction. Such a token may be presented by a user to a vendor in a value-based transaction with the purpose of transferring value involved in the transaction to the vendor in order to complete the transaction.

### BACKGROUND OF THE INVENTION

The present invention relates to value-based transactions, and more particularly to techniques that enable a user to generate a token that can be used in a value-based transaction to transfer value to a vendor in a way that is secure and maintains anonymity of the user and the source of the value and maintains secrecy of information that should preferably not be disclosed to an untrusted third party such as a vendor.

Cash has traditionally been used as value in value-based transactions. This is primarily due to its convenience of use. You can hand someone a $20 bill and they can use it for a variety of purposes such as buying dinner, going to a movie, giving it away to someone else, or even saving it for later use. However, this convenience also has its downside. For example, a parent may transfer money to a child's account for payment of college tuition; however, the child may instead use the money to buy a new stereo and music CDs. As another example, you may pay a contractor to purchase building materials and then discover that it was used to pay a debt owed by the contractor. The universal purchase power of cash also makes it very dangerous to carry and a target of thefts.

More recently, the use of credit cards instead of cash has been on the upsurge. However, the use of credit cards also has inherent risks involved. When a card is presented to a vendor for a transaction, the card number is disclosed to the non-trusted vendor. The card information is thus available for fraudulent unauthorized use by the vendor. Further, credit cards are frequently lost or stolen and charges made against the lost or stolen credit card.

In light of the above, improved and secure techniques are desired for transferring value to vendors in value-based transactions.

### BRIEF SUMMARY OF THE INVENTION

Embodiments of the present invention provide techniques for generating a token that can be used to transfer value. The token may be used to transfer value in a value-based transaction with a vendor in a secure and safe manner that maintains anonymity of the source of the value and maintains secrecy of information that should preferably not be disclosed to an untrusted third party such as a vendor. The token comprises sufficient information that enables value to be transferred from an account associated with the token to a vendor during a value-based transaction. Such a token may be presented by a user to a vendor in a value-based transaction with the purpose of transferring value involved in the transaction to the vendor in order to complete the transaction.

According to an embodiment of the present invention, techniques are provided for generating a token. In one embodiment, information is received identifying an account and identifying an entity authorized to transfer value from the account. A token is generated comprising token information, the token information comprising information identifying the account and information identifying the entity, wherein at least the information identifying the account is encrypted and the token enables value to be transferred from the account. In one embodiment, the information identifying the account is encrypted using a public encryption key of the entity authorized to transfer value from the account. The entity authorized to transfer value from the account may be an entity holding the account (e.g., a bank holding a bank account) or some other entity such as a clearinghouse. In one embodiment, the token enables monetary value to be transferred from a bank account. A token may be provided to a first vendor in order to transfer value to the first vendor in a value-based transaction.

Information may also be received identifying an item or a class of items, and the token information associated with the token may comprise information identifying the item or the class of items and the token enables value to be transferred from the account for a transaction involving the item or an item in the class of items. Information may also be received identifying a vendor or a class of vendors, and wherein the token information comprised information identifying the vendor or class of vendors and the token enables value to be transferred from the account to the vendor or to a vendor within the class of vendors. In one embodiment, authorization information (e.g., a PIN, an electronic signature) may be received, encrypted and associated with the token.

According to an embodiment of the present invention, the token that is generated may be an electronic token or a physical token. A portion of the token information associated with a token may be encoded in machine readable information associated with the token.

According to an embodiment of the present invention, information may be received identifying a value limit and wherein the token information comprises information identifying the value limit and the token enables transfer of value up to the value limit.

According to an embodiment of the present invention, techniques are provided for performing a transaction. Token-related information from a token may be obtained at a vendor system of a vendor. The token-related information may comprise information identifying an account and information identifying an entity authorized to transfer value from the account, wherein the information identifying the account is encrypted. The encrypted information identifying the account may be communicated from the vendor system to the entity authorized to transfer value from the account. Transaction information comprising information related to a transaction may be communicated from the vendor system to the entity. The transaction information may identify a value to be transferred to the vendor. A code may be received at the vendor system from the entity indicating approval or rejection of transfer of the value to the vendor. In one embodiment, the token-related information may additionally comprise information identifying an item or a class of items and may be from the vendor system to the entity and the transaction information communicated to the entity may comprise information identifying an item involved in the transaction. In another embodiment, the token-related information may comprise information identifying a vendor or a class of vendors and may be communicated from the vendor system to the entity, and wherein the transaction information communicated to the entity may comprise information identifying the vendor. In yet another embodiment, the token-related information may comprise information identifying a value limit, and this information may be communicated from the vendor system to the entity. In one embodiment, token-related information may be encoded in a machine readable code printed on the token.

According to an embodiment of the present invention, techniques are provided for transferring value for a transaction. Token-related information may be received from a first system, wherein the token-related information is obtained by the first system from a token. The token-related information may comprise encrypted information identifying an account. Transaction information may also be received from the first system, the transaction information related to a transaction and identifying a vendor and a value to be transferred to the vendor. The encrypted information identifying the account may be decrypted. Transfer of the value identified in the transaction information from the account to the vendor may be approved or rejected.

In one embodiment, the token-related information received from the first system comprises information identifying an item or a class of items and information identifying a vendor or a class of vendors and the transaction information identifies an item involved in the transaction. Approving or rejecting the transfer may comprise: determining if the vendor identified in the transaction information is same as the vendor identified in the token-related information or is a vendor that satisfies the class of vendors identified in the token-related information; determining if the item identified in the transaction information is same as the item identified in the token-related information or is an item that satisfies the class of items identified in the token-related information; and approving the transfer of the value from the account upon determining that the vendor identified in the transaction information is same as the vendor identified in the token-related information or is a vendor that satisfies the class of vendors identified in the token-related information and the item identified in the transaction information is same as the item identified in the token-related information or is an item that satisfies the class of vendors identified in the token-related information. The value identified in the transaction information may be transferred to the vendor. In one embodiment, transferring the value comprises transferring monetary value equal to the value identified in the transaction information from a bank account to the vendor.

The foregoing, together with other features, embodiments, and advantages of the present invention, will become more apparent when referring to the following specification, claims, and accompanying drawings.

### BRIEF DESCRIPTION OF THE DRAWINGS

FIG. 1 depicts an example of a token that may be used to transfer value according to an embodiment of the present invention;

FIG. 2 is a simplified block diagram of a system that may be used to generate a token according to an embodiment of the present invention;

FIG. 3 is a simplified high-level flowchart depicting a method of generating a token according to an embodiment of the present invention;

FIG. 4 is a simplified high-level flowchart depicting a method of using a token according to an embodiment of the present invention;

FIG. 5 is a simplified high-level flowchart depicting a method of determining whether or not to approve transfer of value for a token according to an embodiment of the present invention;

FIG. 6 depicts a system which may incorporate an embodiment of the present invention;

FIG. 7 depicts a system which may incorporate another embodiment of the present invention; and

FIG. 8 is a simplified block diagram of a computer system that may be used to perform processing according to an embodiment of the present invention.

### DETAILED DESCRIPTION OF THE INVENTION

In the following description, for the purposes of explanation, specific details are set forth in order to provide a thorough understanding of the invention. However, it will be apparent that the invention may be practiced without these specific details.

Embodiments of the present invention provide techniques for generating a token that can be used to transfer value. The token may be used to transfer value in a value-based transaction with a vendor in a secure and safe manner that maintains anonymity of the source of the value and maintains secrecy of information that should preferably not be disclosed to an untrusted third party such as a vendor. The token comprises sufficient information that enables value to be transferred from an account associated with the token to a vendor during a value-based transaction. Such a token may be presented by a user to a vendor in a value-based transaction with the purpose of transferring value involved in the transaction to the vendor in order to complete the transaction. For example, a token may be generated that is associated with a bank account storing monetary value. In a financial transaction between a user and a vendor (e.g., user purchasing a book from a bookseller), the user may provide the token to a vendor in order to transfer value to the vendor for the value-based transaction. In this manner, the token acts as a substitute for cash or monetary value.

The scope of the present invention is however not limited to cash or monetary value. Tokens may also be used to transfer other types of value such as frequent flier miles, loyalty points, or anything that has exchange value in a transaction.

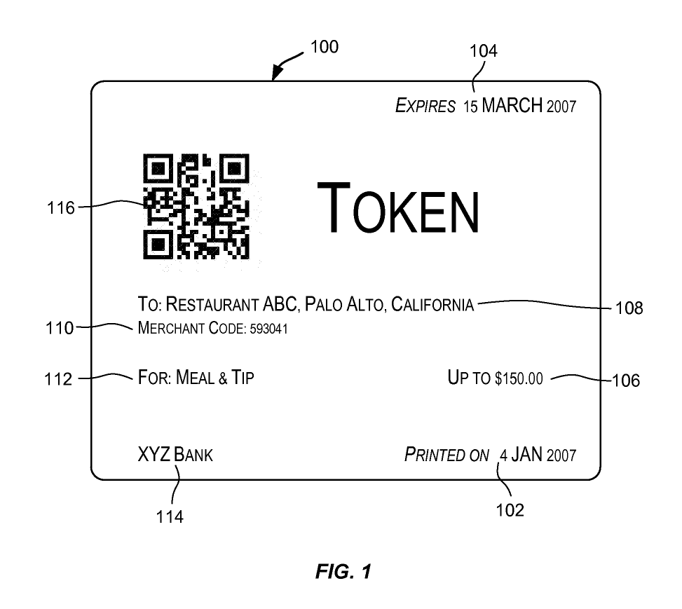

FIG. 1 depicts an example of a token 100 that may be used to transfer value according to an embodiment of the present invention. Token 100 may be a digital token such as an electronic image or a physical token generated using a physical medium such as paper, card, plastic, etc. Token 100 may be generated by a user for later use. Token 100 depicted in FIG. 1 is merely illustrative of an embodiment of the present invention and does not limit the scope of the invention as recited in the claims. One of ordinary skill in the art would recognize other variations, modifications, and alternatives.

Token 100 comprises sufficient information that enables value to be transferred from an account to a vendor. For example, token 100 enables monetary value to be transferred to a vendor from a bank account. Token 100 may comprise human-readable or machine readable information. The human-readable information is optional and may comprise various types of information related to the token. In FIG. 1, the human-readable information printed on token 100 comprises information 102 identifying a date when token 100 was generated, information 104 identifying an expiration date for token 100, information 106 identifying a maximum monetary value that may be transferred using token 100, information 108 and 110 identifying a specific vendor to whom monetary value may be transferred using token 100, information 112 specifying a specific item for which monetary value may be transferred using token 100, and information 114 identifying a bank holding an account from which monetary value is transferred using token 100. The human-readable information that is printed on a token may vary from one token to another and may not even be present in certain embodiments of the token.

Token 100 also comprises machine readable information in the form of machine readable code 116. In one embodiment, the information that is used for transferring value is all encoded in machine readable code 116. Code 116 may be easily read by a vendor system and the value-based transaction may be completed between the vendor and the user with a single simple interaction. Code 116 may be in various forms such as a 2-dimensional barcode like a QR code, PDF417 code, a glyph (e.g., a Xerox glyph), machine-readable text, an image, a symbol, and the like, and combinations thereof. Code 116 is typically easily printable or simple to create and display on a portable display such as a cell phone display. Information encoded by machine-readable code 116 or portions thereof may also be printed in human-readable form on token 100.

As indicated, machine readable code 116 may encode information that enables value to be transferred to a vendor from an account associated with the token. Machine readable code 116 may encode information such as information identifying an entity holding an account from which value can be transferred using token 100. For example, machine-readable code 116 may encode information identifying a bank holding an account from which money may be transferred when token 100 is used in a financial transaction. Machine-readable code 116 may also encode information identifying the bank account from which value may be transferred using token 100.

Machine-readable code 116 may also encode authorization or proof of identification information that is provided to a bank to prove the identity of the user of token 100. The authorization information may be a unique ID, a personal identification number (PIN), an electronic signature, etc. This authorization information is used as proof of identity by the bank to guard against forgery and is a useful security feature.

Other information that may be encoded by machine-readable code 116 may include an expiration data associated with token 100, a maximum limit on the value that may be transferred using token 100, information identifying a specific vendor or class of vendors that is permitted to receive value using token 100, a type of item (e.g., a good or a service) or a class of items that may be purchased using token 100 and for which value transfer is permitted.

Machine-readable code 116 may also encode a token identifier (token ID) that is used to identify token 100. In the event that token 100 is lost, the token may be canceled by the user by providing a cancellation request with the token ID corresponding to the token to the bank. The bank will then reject any request to transfer value using that token ID.

One or more pieces of information encoded by machine-readable code 116 may be in encrypted form such that a vendor cannot decrypt the information. Encryption is used to prevent sensitive information from being disclosed to the vendor. For example, account information and user identify or authorization information is encrypted. This helps in maintaining anonymity of the user of the token and anonymity of the source of the value and also preserves secrecy of information that should preferably not be disclosed to an untrusted third party such as a vendor. Putting encrypted authorization information (e.g., an encrypted PIN) on token 100 enables a bank holding the account from which monetary value is to be transferred to determine that token 100 was created by a person authorized to use the account held by the bank without revealing the identification of the user to a non-trusted third party. The encrypted information may be decipherable by the bank holding the account from which monetary value is transferred upon use of the token. The information may have been encrypted using a public key of the bank. For example, the bank account information and the PIN may be encrypted using the bank's public key such that only the bank can decrypt the encrypted information.

A token may comprise both encrypted and non-encrypted information. For example, the account information and the authorization information associated with a token are encrypted while the bank information associated with token is not encrypted. A vendor may use the non-encrypted information obtained from a token to determine an entity (e.g., a bank) to which a request for value transfer is to be sent. Accordingly, sufficient non-encrypted information may be associated with a token that enables a vendor to initiate a request for transfer of value during a value-based transaction. However, user-specific information such as the account information and the user authorization information (e.g., PIN, electronic signature) that may reveal the user's identity is encrypted such that the information is not disclosed to the vendor. In this manner, a token comprises information that enables value to be transferred in a value-based transaction securely and anonymously while preserving secrecy of information that should preferably not be disclosed to an untrusted third party such as a vendor.

Information identifying the expiration date for the token, the items or class of items that may be purchased using the token, and the token ID associated with a token may be encrypted or not encrypted. Information associated with the token identifying the maximum value associated with the token and the vendor or class of vendors permitted to receive value may be optionally encrypted or not encrypted. In one embodiment, all the information associated with a token is encrypted.

Restrictions may be imposed upon the use of a token. A token may be generated for a planned transaction and its use restricted to the planned transaction. Information identifying the restrictions may be printed in human-readable form on the token or may be encoded in the machine readable information associated with the token. For example, as depicted in FIG. 1, token 100 is restricted to a particular vendor, namely, “Restaurant XYZ” in Palo Alto, Calif. Accordingly, token 100 may be used only in a transaction with Restaurant XYZ in Palo Alto, Calif. In other embodiments, the use of a token may be restricted to a specific class of vendors, allowing more flexibility in how the token is used. In yet other embodiments, there may be no restrictions imposed on the use of token 100.

The use of a token may also be restricted to transactions involving a particular item (a good or service). For example, token 100 depicted in FIG. 1 may be only be used to transfer monetary value for payment of a meal and tip. In other embodiments, the use of a token may be restricted to a specific class of items, allowing more flexibility in how token 100 is used. In yet other embodiments, there may be no restrictions imposed on the use of token 100.

The value that may be transferred using token 100 may also be restricted. For example, an upper limit may be imposed on the value that may be transferred to a vendor using a token. For example, token 100 depicted in FIG. 1 may be used to transfer at most $150 to Restaurant XYZ in Palo Alto, Calif. In alternative embodiments, no monetary limit may be imposed.

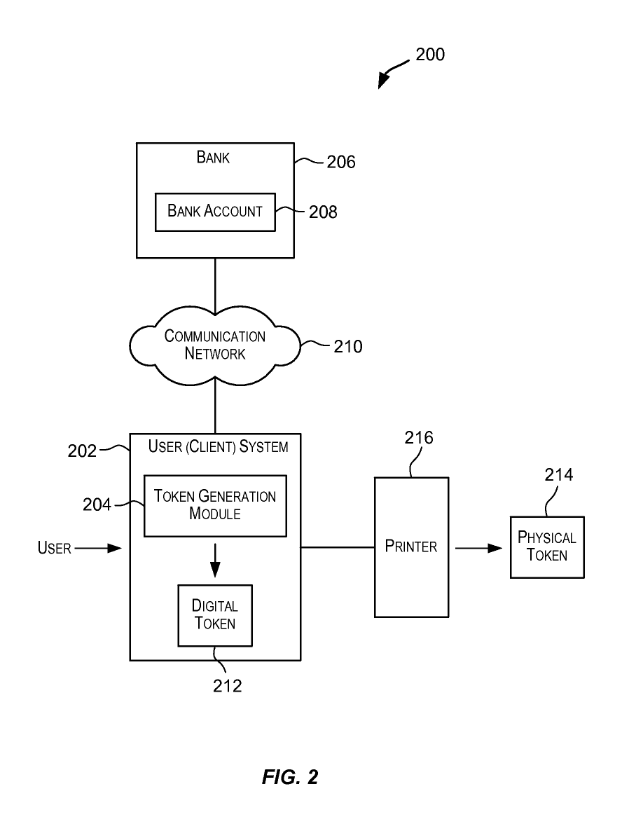

A token such as token 100 depicted in FIG. 1 may be generated by a user prior to use of the token. The token may be generated as and when needed. FIG. 2 is a simplified block diagram of a system 200 that may be used to generate a token according to an embodiment of the present invention. System 200 depicted in FIG. 2 is merely illustrative of an embodiment incorporating the present invention and does not limit the scope of the invention as recited in the claims. One of ordinary skill in the art would recognize other variations, modifications, and alternatives.

A user may use a user client system 202 to generate a token according to an embodiment of the present invention. User system 202 may comprise a token generation module 204 that facilitates generation of tokens. Token generation module 204 may be implemented in software comprising code and instructions that are executed by a processor, in hardware, or combinations thereof. For example, token generation module 204 may be software loaded on system 202 and which when executed by a processor of user system 202 facilitates generation of tokens.

As described above, a token may be used to transfer value from an account. A token is thus associated with an account storing value, such as a bank account held by a bank. For example, as depicted in FIG. 2, a bank 206 may hold a bank account 208 from which monetary value (e.g., cash) may be transferred using a token according to the teachings of the present invention.

The user may specify various pieces of information that are used by token generation module 204 for generating a token. Token generation module 204 may provide various interfaces for collecting information from the user. For example, the user may specify a bank and a bank account held by the bank that is to be associated with a token and from which money will be transferred when the token is used. Optionally, for security purposes, the user may specify authorization information such as a PIN or password or electronic signature or some secret information. The authorization information is used by the bank to verify identify of the user of the token so as to guard against forgeries. The user may optionally specify a value restriction for the token such as a maximum limit on the money that may be transferred using the token. The user may also optionally specify a specific vendor or class of vendors to whom transfer of value is permitted using the token. The user may also optionally specify a specific item (a good or service) or a class of items which may be purchased using the token. A user may optionally specify an expiration time limit for the token to be generated. The user may also specify other pieces of information to be associated with the token to be generated.

Token generation module 204 is then configured to generate a token based upon the information provided by the user. In one embodiment, module 204 generates the machine-readable information and human-readable information that is to be associated with the token. Module 204 may use coding and encryption technology in the generation of the token. For example, one or more pieces of information (e.g., bank account information) associated with the token may be encrypted to prevent the information from being disclosed to the non-trusted vendor. In one embodiment, module 204 may use the public encryption key(s) of the bank holding the account to be associated with the token to encrypt the information. The bank's public encryption keys may be provided to module 204. In alternative embodiments, module 204 may be configured to download the encryption keys information from bank 206. For example, as depicted in FIG. 2, user system 202 may be communicatively coupled with bank 206 via communication network 210 and may be configured to establish a connection to bank 206 and download the encryption keys information.

User system 202 may generate a digital token 212 or a physical token 214. Digital token 212 may be stored in a memory of user system 202 and may be in the form of an image, a data file, etc. Physical token 214 may be generated using printer 216 (or other printer-like output device). In order to generate physical token 214, module 204 may be configured to send tokens-related information to printer 214 that prints a physical token 214 using a physical medium such as paper, plastic, etc. Whether in digital or physical form, the token comprises sufficient information that enables value to be transferred from an account (e.g., bank account 208) to a vendor as part of a value-based transaction.

In one embodiment, the functions performed by token generation module 204 may be incorporated into printer 216. In this scenario, there is no need for a separate user system. A user may interact directly with the printer to specify information for a token and the printer may be configured to generate a token.

Token generation module 204 may comprise a “capture module” that is configured to collect the information from a user and a “generate module” that is configured to generate a token based upon the user-provided information. The capture module and the generate module may be implemented in software (program or code or instructions), hardware, or combinations thereof.

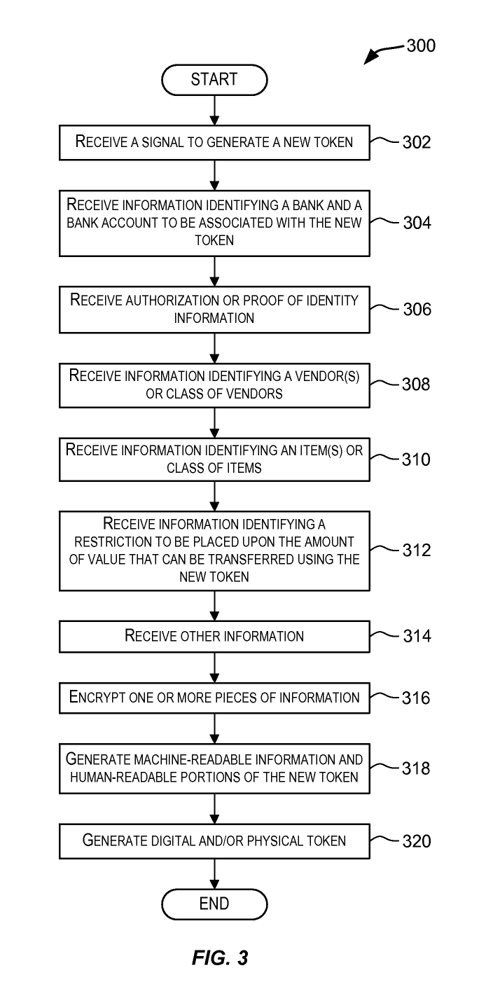

FIG. 3 is a simplified high-level flowchart 300 depicting a method of generating a token according to an embodiment of the present invention. The method depicted in FIG. 3 may be performed by software modules (code modules or instructions) executed by a processor, hardware modules, or combinations thereof. For example, the method may be performed by token generation module 204 depicted in FIG. 2. Flowchart 300 depicted in FIG. 3 is merely illustrative of an embodiment of the present invention and is not intended to limit the scope of the present invention. Other variations, modifications, and alternatives are also within the scope of the present invention. The method depicted in FIG. 3 may be adapted to work with different implementation constraints. The method depicted in FIG. 3 and described below assumes that the token is generated for monetary value stored by a bank account. In alternative embodiments, tokens may be generated for other types of values.

As depicted in FIG. 3, processing is triggered upon receiving a signal to generate a new token (step 302). In one embodiment, a user may start token generation module 204 on user system 202. Module 204 may provide several user-selectable options (e.g., via buttons, menus, etc,) for initiating generation of a token.

A user may then specify information to be used for generating the token. Information may be provided by the user and received by the module generating the token identifying a bank (or any entity that is authorized to transfer value from an account associated with the token to be generated) and a bank account to be associated with the token to be generated (step 304). The bank account identifies an account from which monetary value will be transferred when the token being generated is used. Optionally, authorization or proof of identity information may be received (step 306). The information received in 306 may include a PIN code, an electronic signature, a password, or other information that may be used by an entity authorized to transfer value from the account (e.g., a bank holding the account, a clearinghouse) to authenticate a request for transferring value.

As previously described, restrictions may be placed upon the use of a token. For example, the use of the token may be restricted to a particular vendor. Accordingly, information is optionally received identifying a vendor(s) or class of vendors that is permitted to receive value using the token (step 308). Only the specified vendor(s) or class of vendors is permitted to receive value using the new token to be generated.

The use of a token may also be restricted to a particular item (a good or service) or class/type of items. Accordingly, information is optionally received identifying an item(s) or class of items for which the token may be used (step 310). Restrictions may also be placed on the amount of value associated with a token. Accordingly, information is optionally received identifying a restriction to be placed upon the amount of value that can be transferred using the token (step 312). For example, in 312, information may be received identifying an upper bound or limit on the amount of value that can be transferred using the new token. Other information related to the token to be generated may also optionally be received (step 314). The information received in 314 may include for example, the expiration date or time limit for the token, a transaction identifier for the token, etc. For the various pieces of information received in flowchart 300, user interfaces (e.g., graphical user interfaces) may be provided that enable a user generating the token to provide the requisite information.

One or more pieces of the received information may be encrypted (step 316). Information that may reveal the identity of the user (either the generator of the token or the user of the token) or that may reveal a secret known only to the user and the bank (e.g., a PIN) is usually encrypted such that it is not revealed to the vendor when the token is used. This helps maintain anonymity of the user and also maintains secrecy of information that should preferably not be disclosed to an untrusted third party such as a vendor. For example, the account information and the user authorization information is encrypted. Different techniques may be used for encrypting the information. In one embodiment, the information may be encrypted using the public encryption key(s) of the entity (e.g., bank) holding the value account (e.g., bank account) or the entity (e.g., a bank or a clearinghouse) authorized to transfer value from the account. The information associated with a token may also comprise non-encrypted information. For example, information identifying the entity that is authorized to transfer value from an account such as a bank or a clearinghouse may not be encrypted. When a token is used, a vendor may use the non-encrypted information associated with the token to determine an entity to which a value transfer request is to be sent. In one embodiment, all the information may be encrypted.

The machine-readable information and human-readable portions of the token are generated (step 318). The human-readable information enables a user of the token to know the intended use(s) of the token. The machine-readable information may encode information such as the bank information, account information, authorization information, token transaction identifier, expiration date for the token, restrictions (e.g., vendor or item or value restrictions) placed upon the token, etc. In one embodiment, the machine-readable information is in the form of a barcode such as a QR code that may be read using a barcode reader.

A digital or physical token is then generated (step 320). A physical token may be generated using a device such as a printer that generates a printed token using a physical medium. The generated token (digital or physical) may then be used by a user. The user of the token may be the user that caused the token to be generated or some other user (e.g., a parent may generate a token to be used by his son or daughter).

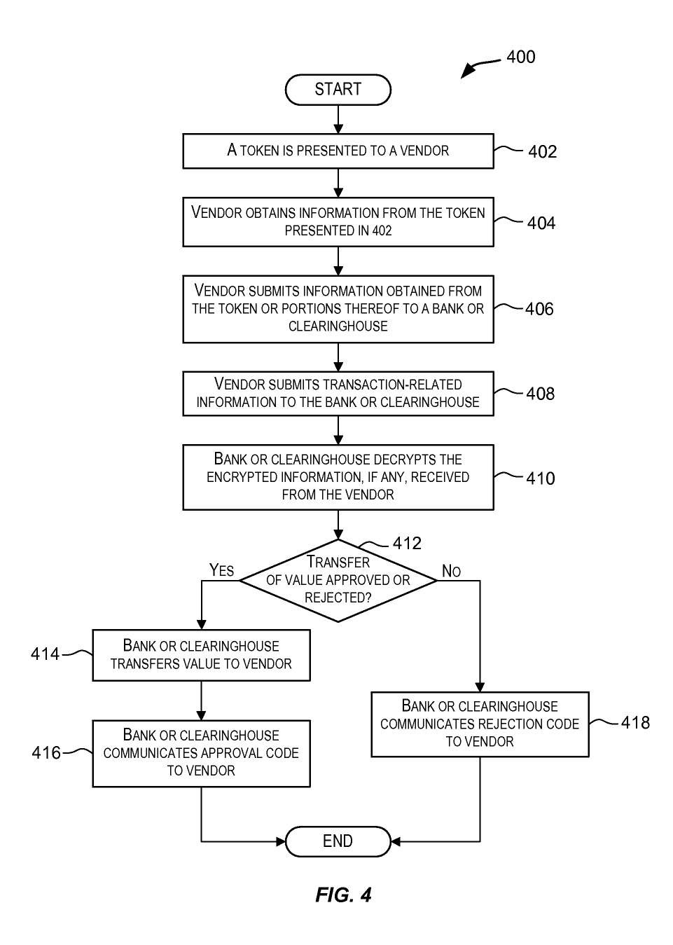

FIG. 4 is a simplified high-level flowchart 400 depicting a method of using a token according to an embodiment of the present invention. The method depicted in FIG. 4 may be performed by software (code modules or instructions) executed by a processor, hardware modules, or combinations thereof. Flowchart 400 depicted in FIG. 4 is merely illustrative of an embodiment of the present invention and is not intended to limit the scope of the present invention. Other variations, modifications, and alternatives are also within the scope of the present invention. The method depicted in FIG. 4 may be adapted to work with different implementation constraints. The method depicted in FIG. 4 assumes that the token is generated for monetary value stored by a bank account.

As depicted in FIG. 4, a user may present a token to a vendor either physically or electronically (step 402). A vendor may be any entity such as a merchant, a restaurant, a hospital, a bookseller, an educational institution, an organization, a person, etc. or a system or device used by the entity. Presenting a token to the vendor may involve giving the token to the vendor, making the token available for reading by a vendor system (e.g., a barcode reader), electronically communicating a token to a vendor or vendor system, and the like. For example, a consumer may provide a token to a vendor at the point-of-sale.

Information from the token is then obtained by the vendor or vendor system (step 404). The information that is obtained may include human-readable information associated with the token being presented and/or machine readable information. In one embodiment, only the machine readable information is obtained by a vendor system. For example, a barcode reader may be used to read the barcode printed on the token.

The information read from the token may include encrypted and/or non-encrypted information. For example, the encrypted information may include information identifying the bank account information and user authorization information, while the non-encrypted information may include information identifying an entity authorized to transfer the value such as a bank holding a bank account or a clearinghouse authorized to handle value transfer requests.

The vendor may then submit a request to the entity that is authorized to transfer value for the token such as a bank or clearinghouse requesting transfer of value for a transaction. In one embodiment, the entity to which the request is sent may be identified in the non-encrypted information obtained from the token in 404. As part of submitting the request, the vendor may submit the information obtained from the token or portions thereof to the bank or clearinghouse or to the entity that is authorized to facilitate transfer of value for the token (step 406). In one embodiment, only the encrypted information captured from the token may be communicated to the bank or clearinghouse. In other embodiment, both encrypted and non-encrypted information obtained from the token in 404 may be submitted in 406.

As part of the value transfer request, the vendor may also submit transaction-related information to the bank or clearinghouse (step 408). The transaction-related information may specify details related to the transaction for which the token is being used. This information may include the vendor's identity, information related to one or more items (product or service) involved in the transaction, value to be transferred in the transaction (e.g., prices associated with the item(s) involved in the transaction), and other information. The items information may be in the form of Universal Product Codes (UPC) codes, product identifiers, and the like. The information submitted in 408 may also include information identifying the vendor's value receiving entity (e.g., the vendor's bank) and the vendor's account information. This information may be used in step 414, as described below, to determine where to transfer the value.

The bank or clearinghouse is then configured to decrypt the encrypted information, if any, received from the vendor (step 410). The decryption may be done using the bank's or clearinghouse's private encryption key.

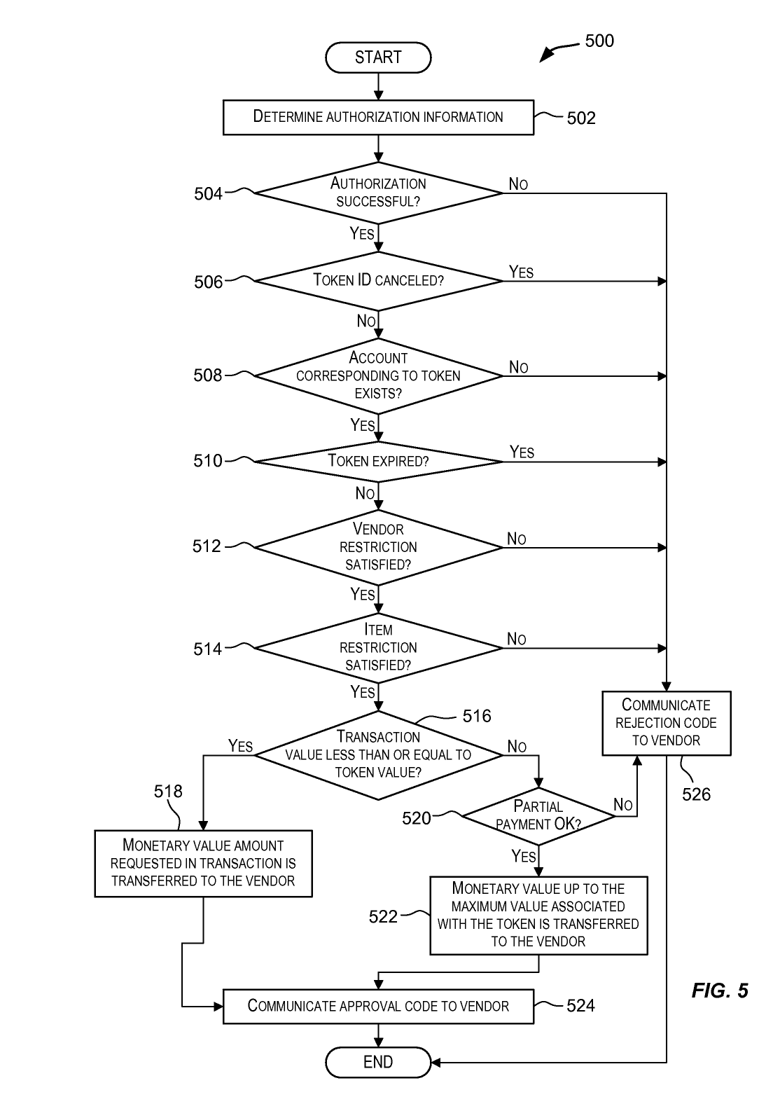

Based upon the token and transaction information received from the vendor, the bank or clearinghouse then determines whether the request for transferring value to the vendor using the token is to be approved or rejected (step 412). Various different checks may be performed by the bank or clearinghouse in determining whether or not to approve the value transfer. FIG. 5 described below provides an example of processing that may be performed to determine whether or not to approve the value transfer for the transaction.

If it is determined in 412 that the value transfer is approved, the value associated with the transaction may then be transferred to the vendor (step 414). Value may be transferred by deducting the value associated with the transaction from the bank account corresponding to the token and crediting a vendor's account with the value. For example, a bank account associated with the token may be debited for the transaction amount and the vendor's bank account may be credited with the transaction amount (up to the amount restrictions placed on the token). As indicated above, in step 408, a vendor may submit information identifying the vendor's bank and bank account. The value may be transferred to the bank and account specified by the vendor. Value may also be transferred to the vendor in other ways.

An approval code may be then communicated by the bank or clearinghouse to the vendor after value has been successfully transferred in 414 (step 416). The value-based transaction between the user and the vendor may be completed upon receipt by the vendor of the approval code and/or the transfer of value to the vendor.

If it is determined in 412 that the value transfer is not approved, then a rejection code may be communicated by the bank or clearinghouse to the vendor (step 418). The rejection code may comprise information identifying the reason for the rejection. In this case, transfer of value is not permitted.

FIG. 5 is a simplified high-level flowchart 500 depicting a method of determining whether or not to approve transfer of value for a token according to an embodiment of the present invention. The method depicted in FIG. 5 may be performed by software (code modules or instructions) executed by a processor, hardware modules, or combinations thereof. The method may be performed by a bank or clearinghouse or an entity that is authorized to transfer value. Flowchart 500 depicted in FIG. 5 is merely illustrative of an embodiment of the present invention and is not intended to limit the scope of the present invention. Other variations, modifications, and alternatives are also within the scope of the present invention. The method depicted in FIG. 5 may be adapted to work with different implementation constraints. The method depicted in FIG. 5 assumes that a determination is to be made whether or not to approve transfer of monetary value from a bank account to a vendor for a token. In one embodiment, the processing depicted in FIG. 5 may be performed in real time while the user waits at the vendor's place to complete the transaction.

The determination of whether or not to approve the value transfer to the vendor is based upon token-related information and transaction-related information received from the requesting vendor. The bank may determine the authorization information from the token-related information received from the vendor (step 502). The authorization information is typically encrypted so that the information is not disclosed to a non-trusted vendor. The bank may decrypt the information using, for example, the bank's private encryption key. Examples of authorization information include a Personal Identification Number (PIN), an electronic signature, etc. The bank then determines if the authorization information is successfully authenticated (step 504). In one embodiment, authentication may involve using the authorization information to validate the identity of the user using the token or who generated the token. If it is determined that authentication is not successful, then a rejection code may be communicated to the vendor (step 526) and processing is terminated preventing transfer of value to the vendor. In this manner, the authorization information helps to guard against forgery and fraudulent practices.

If it is determined in 504 that authentication is successful, then a check may be made to see if the token identifier associated with the token has been canceled (step 506). As previously described, a token identifier is associated with a token when the token is generated and is used to uniquely identify the token. A user may cancel a token by canceling the corresponding token identifier. For example, if a user loses a token and would like to prevent unauthorized use of the token, the user may call the bank holding the account associated with the token and cancel the token identified by the token identifier. Accordingly, a check is made in 506 to see if the token identifier is canceled. The token identifier information may be included in the tokens-related information received by the bank from the vendor. If it is determined that the token has been canceled, then a rejection code is communicated to the vendor according to step 526 and processing is terminated.

If it is determined in 506 that the token is not canceled, then a check is made to see if the bank holds an account corresponding to the token (step 508). Information identifying the bank account may be included in the tokens-related information received from the vendor. This information is typically in encrypted form and may be decrypted by the bank. If it is determined in 508 that the bank does not hold an account corresponding to the token, then a rejection code is communicated to the vendor according to step 526 and processing is terminated.

If it is determined in 508 that the bank holds an account identified by the tokens-related information, then a check is made to see if the token has expired (step 510). As previously described, an expiration time may be associated with a token and a check is made in 510 if the expiration time has been exceeded. If it is determined in 510 that the token has expired, then a rejection code is communicated to the vendor according to step 526 and processing is terminated.

If it is determined in 510 that the token has not expired, then a check is made to see if the vendor to whom value is to be transferred satisfies vendor restrictions, if any, associated with the token (step 512). As previously described, when a token is generated, restrictions may be imposed specifying the vendor(s) or class of vendors to whom value may be transferred using the generated token. In this manner, the use of the token may be restricted to a particular vendor(s) or class of vendors. Information identifying the vendor (e.g., a vendor name, vendor code) requesting the value transfer is usually included in the transaction-related information received by the bank from the vendor. Vendor-related restrictions associated with a token are specified in the tokens-related information received by the bank from the vendor. Accordingly, a check is made in 512 to determine if the vendor requesting the value transfer matches the vendor(s) or class of vendors associated with the token. If it is determined in 512 that the token vendor restrictions are not satisfied, then a rejection code is communicated to the vendor according to step 526 and processing is terminated.

If it is determined in 512 that the vendor requesting the value transfer satisfies the vendor or class of vendors restrictions associated with the token, then a check is made to see if the item(s) involved in the transaction satisfy the item restrictions, if any, associated with the token (step 514). As previously described, when a token is generated, restrictions may be imposed limiting the items (which may include goods or services) or class of items purchasable using the generated token. In this manner, the use of the token may be restricted to a particular item(s) or class of items. Information identifying the items is usually included in the transaction-related information received by the bank from the vendor. Item-related restrictions with a token are specified in the tokens-related information received by the bank from the vendor. Accordingly, a check is made in 514 to determine if the item(s) being purchased in the transaction fall within the item(s) or class of items associated with the token. If it is determined in 514 that the item(s) being purchased do not satisfy the item restrictions associated with the token, then a rejection code is communicated to the vendor according to step 526 and processing is terminated.

If it is determined in 514 that the item(s) involved in the transaction is included in the item(s) or class of items associated with the token, then the value involved in the transaction and being requested by the vendor is compared to the value limit, if any, associated with the token (step 516). If it is determined in 516 that the monetary value requested in the transaction is less than or equal to the maximum value associated with the token, then the monetary value amount requested in the transaction is transferred to the vendor (step 518). The value may be transferred to the vendor is different ways. In one embodiment, the value may be transferred to a system used by the vendor. In another embodiment, the value may be transferred to an account of the vendor.

An approval code is then communicated to the vendor (step 524). As part of 524, the information communicated to the vendor may also include information identifying the amount of value transferred to the vendor.

If it is determined in 516 that the monetary value requested in the transaction is greater than the maximum value associated with the token, then a check is made to see if partial payment for the transaction is allowed (step 520). Whether or not a partial payment is allowed may be dependent upon the vendor, the bank holding the account, the type of transaction, and other factors. If it is determined in 520 that a partial payment is not allowed, then a rejection code is communicated to the vendor according to step 526 and processing is terminated. If it is determined in 520 that a partial payment is permitted, then a monetary value up to the maximum value associated with the token is transferred to the vendor (step 522). In this manner, the value that is transferred is restricted to the maximum limit specified for the token being used. An approval code may then be communicated to the vendor according to step 524.

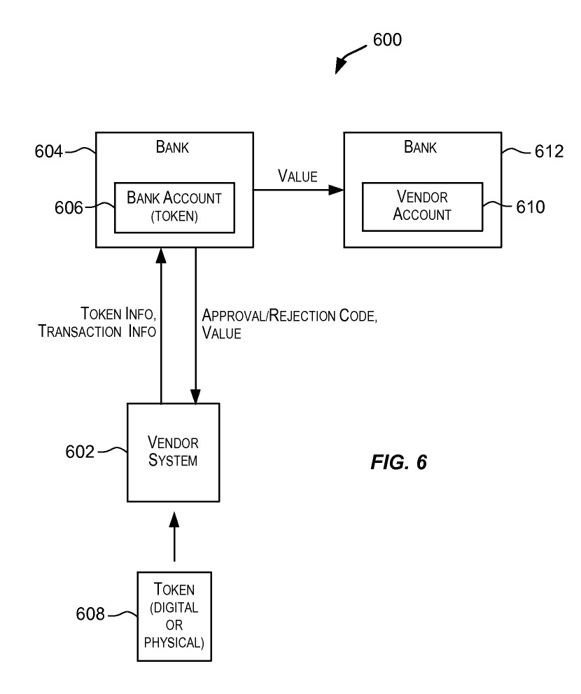

FIG. 6 depicts a system 600 which may incorporate an embodiment of the present invention. System 600 depicted in FIG. 6 is merely illustrative of an embodiment incorporating the present invention and does not limit the scope of the invention as recited in the claims. One of ordinary skill in the art would recognize other variations, modifications, and alternatives.

As depicted in FIG. 6, a vendor system 602 is communicatively coupled to a bank 604 holding an account 606. A user may present a token 608 (which may be a digital token or a physical token) to vendor system 602 for a particular transaction. Vendor system 602 may be configured to capture information from the presented token. Vendor system 602 may communicate the token information captured from token 608 (or a portion thereof) and transaction-related information to bank 604. The information communicated to bank 604 may include encrypted information specifying a bank account and a PIN associated with the bank account. Bank 604 may be configured to decrypt the encrypted information received from the vendor using the bank's private key. The bank may then determine whether or not to approve transfer of value to the vendor. If approved, an approval code may be communicated to vendor system 602. Bank 604 may transfer value (e.g., monetary value) from account 606 associated with the token to the vendor. This may be done by transferring the value to vendor system 602 or alternatively by transferring the value to a vendor account 610 held by a bank 612.

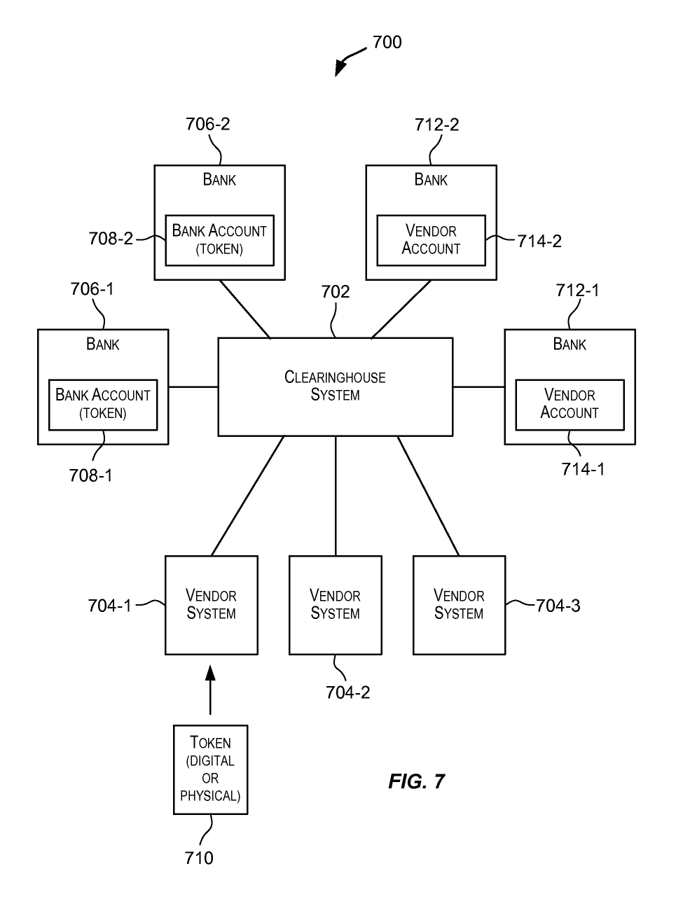

FIG. 7 depicts a system 700 which may incorporate another embodiment of the present invention. System 700 depicted in FIG. 7 is merely illustrative of an embodiment incorporating the present invention and does not limit the scope of the invention as recited in the claims. One of ordinary skill in the art would recognize other variations, modifications, and alternatives.

In FIG. 7, a clearinghouse 702 is communicatively coupled to one or more vendor systems 704-1, 704-2, 704-3 and one or more banks 706-1, 706-2 holding accounts 708-1, 708-2 associated with tokens. A user may present a token 710 (which may be a digital token or a physical token) to vendor system 704-1 for a particular transaction. Vendor system 704-1 may be configured to capture information from the presented token. Vendor system 704-1 may communicate the token information captured from token 710 (or a portion thereof) and transaction-related information to clearinghouse system 702. The information communicated to clearinghouse system 702 may include encrypted information identifying an account associated with the token and authorization information (e.g., PIN) for the account. Clearinghouse system 702 may be configured to decrypt the information received from vendor system 704-1. The decryption may be done using a private key of the clearinghouse. Clearinghouse system 702 may then determine whether or not to approve transfer of value to the vendor. In one embodiment, as part of the processing, clearinghouse system 702 may communicate with the bank holding the account identified by the token information. For example, in one embodiment, clearinghouse system 702 may send the encrypted information received from vendor system 704-1 to the bank holding the account. The bank may then decrypt the information using the bank's private key and determine if transfer of value is to be approved or rejected. The approval or rejection may then be communicated from the bank to clearinghouse system 702. If approved, an approval code may be communicated from clearinghouse system 702 to vendor system 704-1. Value (e.g., monetary value) may also be transferred to the requesting vendor by transferring the value to vendor system 704-1 from the account held by the bank. Clearinghouse system 702 may also be in communication with banks 712-1, 712-2 holding vendor accounts 714-1, 714-2. In alternative embodiments, the value may be transferred to a vendor account either directly from the bank holding the account associated with the token or via clearinghouse system 702.

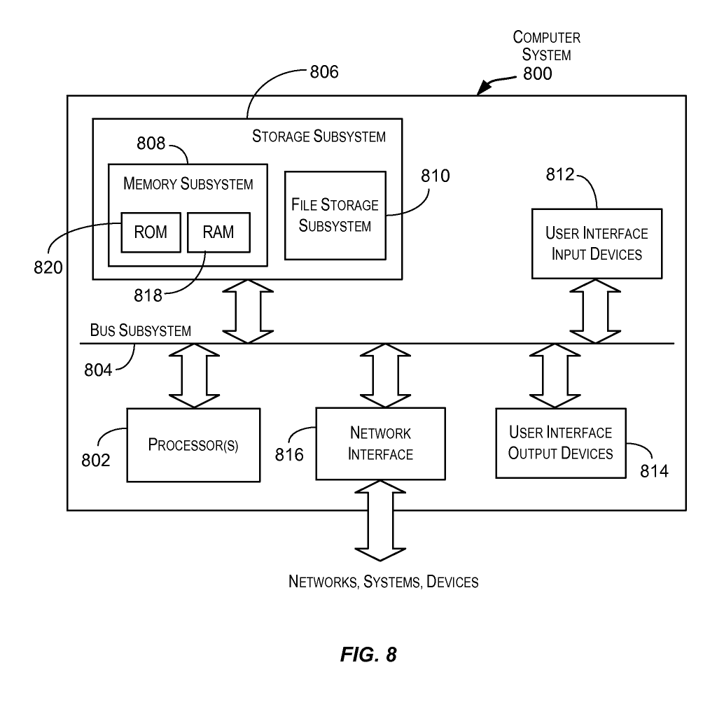

FIG. 8 is a simplified block diagram of a computer system 800 that may be used to perform processing according to an embodiment of the present invention. For example, computer system 800 may serve as user system 202 depicted in FIG. 2 or a vendor system (e.g. vendor system 602) or bank system (e.g., bank system 706, 712) or clearinghouse system (e.g., system 702). As shown in FIG. 8, computer system 800 includes a processor 802 that communicates with a number of subsystems via a bus subsystem 804. These subsystems may include a storage subsystem 806, comprising a memory subsystem 808 and a file storage subsystem 810, user interface input devices 812, user interface output devices 814, and a network interface subsystem 816.

Bus subsystem 804 provides a mechanism for letting the various components and subsystems of computer system 800 communicate with each other as intended. Although bus subsystem 804 is shown schematically as a single bus, alternative embodiments of the bus subsystem may utilize multiple busses.

Network interface subsystem 816 provides an interface to other computer systems, networks, and devices. Network interface subsystem 816 serves as an interface for receiving data from and transmitting data to other systems from computer system 800. For example, a digital token may be communicated to and from computer system 800 using network interface subsystem 816.

User interface input devices 812 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 800. When generating a token, a user may specify information that is to be used for generating the token using input devices 812.

User interface output devices 814 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 800. A digital token may be displayed via an output device 814.

Storage subsystem 806 may be configured to store the basic programming and data constructs that provide the functionality of the present invention. Software (e.g., a computer program comprising code modules or instructions) that when executed by a processor provide the functionality of the present invention may be stored in storage subsystem 806. These software modules or instructions may be executed by processor(s) 802. Storage subsystem 806 may also provide a repository for storing data used in accordance with the present invention. For example, digital tokens may be stored by storage subsystem 806. Storage subsystem 806 may comprise memory subsystem 808 and file/disk storage subsystem 810.

Memory subsystem 808 may include a number of memories including a main random access memory (RAM) 818 for storage of instructions and data during program execution and a read only memory (ROM) 820 in which fixed instructions are stored. File storage subsystem 810 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 800 can be of various types including a personal computer, a portable computer, a workstation, a network computer, a mainframe, a kiosk, or any other data processing system. Due to the ever-changing nature of computers and networks, the description of computer system 800 depicted in FIG. 8 is intended only as a specific example for purposes of illustrating the preferred embodiment of the computer system. Many other configurations having more or fewer components than the system depicted in FIG. 8 are possible.

As described above, tokens may be used in value-based transactions to transfer value to a vendor. The tokens can be printed by a user prior to use. Tokens are thus consumer-printable and contain enough information to allow a consumer and a vendor to complete a value-based transaction (e.g., a financial transaction) with the simplest possible interaction, such as the physical presentation of the token to the vendor or the electronic presentation of the image of the code to a vendor system (e.g., an online system used by the vendor) or communication of a digital token to a vendor.

A consumer may carry one or more tokens and use them like cash for a specific item or items, in a manner that is less risky than carrying cash or a credit card. The information associated with a token, especially private information regarding the user of the token or the source of the value, is generally encoded in machine readable information and is also typically encrypted. Accordingly, when a token is presented to a non-trusted vendor, the confidential private information is not disclosed to the non-trusted vendor as part of completing the transaction. For example, unlike a conventional credit card, the account information is not disclosed to the vendor. A token thus provides a safe way for making anonymous 3rd party payments.

Further, restrictions may be imposed on the use of a token. For example, a token may be generated for a specific vendor or class of vendors and for a specific item or class of items. A maximum value amount may also be specified for a token. Accordingly, the use of a token may be restricted for its intended purpose. This provides a user increased control over his/her assets or value and inappropriate use of the value may be prevented. Tokens enable users to generate their own cash-like substitute for a specific intended use.

Since a maximum value may be associated with a token, the loss due to fraudulent use of the token is limited (if not canceled). Further, tokens may be canceled using their token IDs thereby preventing any transfer of value using the token. As a result, the risk of loss to the account holder due to theft or loss of a token is limited, if any. Tokens thus act as a cash-substitute but in a way that is that is safer than using cash. A token is thus a much safer alternative to using cash or a credit card.

Additionally, using tokens, the value (e.g., money) associated with the token does not leave the user's account until the token is actually used by the user by providing it to a vendor as part of a value-based transaction. Accordingly, no money is transferred until a token is used in a transaction such as when a sale is completed. For example, a token may be used like a gift card for a specific item, but the financial transaction with the bank does not occur until the token is used. Destroying the token prevents the money from leaving the account at all. This is different from a conventional gift card (or gift certificates) or a prepaid card wherein the money has to be paid upfront when the gift card or prepaid card is purchased. Also, tokens can be verified based upon their token ID that they are valid and have not been cancelled without revealing sensitive information to a vendor or a verification device.

A token may be combined with a media key to enable the download of and payment for commercially-owned content in a single digital transaction. The generated media key thereby enables both the download of the video and the payment to be accomplished within a single transaction. Details related to media keys is provided in U.S. application Ser. No. 11/396,264 filed Mar. 31, 2006, the entire contents of which are incorporated herein by reference for all purposes.

A token may be generated as a digital token or a physical token. This offers great flexibility in the manner a token is used. For example, a user may enter into value-based transactions online using a digital token. A token may be communicated electronically or presented in its digital form (e.g., a token displayed on a cell-phone display) or physical form. Transactions with brick and mortar businesses are also facilitated using either digital or physical tokens. A token is thus flexible enough to support both physical and electronic transactions. Typically, the token information that is used for transferring value is in a machine readable information form that can be easily read by a vendor system via a simple “one swipe” of the token. In this manner, payments for transactions may be made in a simple manner.

Tokens according to the teachings of the present invention may be used in a variety of different situations. Some example usage scenarios:

### EXAMPLE 1

Trip to Costa Rica for 2 weeks. Hotels, transportation, food, and entertainment expenses require a traveler to bring credit cards and a large sum of cash or traveler's checks which may not be safe. Instead, the traveler could create tokens, as described above, for various vendors such as for hotels, a variety of restaurants, taxi companies, etc. These tokens could be canceled if they were lost, but unlike traveler's checks, they would not be usable for anything but the services they were originally created for. The traveler also does not have to fear theft of the tokens.

### EXAMPLE 2

Send your child down to the store for a container of milk. You may print a token that is usable for nothing beyond the named item (or class of items) for the specified dollar amount (or up to some modest limit). If the token is lost or stolen, you may cancel the token. Even if the token is not canceled, your financial exposure is very limited to the maximum amount associated with the token.

### EXAMPLE 3

A user wants to download a commercial video using a media key that contains a unique video ID obtained from a commercial website. Before printing out the media key, the user may add token information to the QR code that is subsequently printed on the media key. The media key thereby enables both the download of the video and the payment to be accomplished within a single transaction. Details related to media keys is provided in U.S. application Ser. No. 11/396,264 filed Mar. 31, 2006, the entire contents of which are incorporated herein by reference for all purposes.

### EXAMPLE 4

A recently hired landscaping contractor needs to purchase plants and other gardening supplies. The homeowner makes a list (or agrees on a list) of supplies and creates a token for the supplies. The contractor can present the list and the token to the garden supply center and purchase the supplies. Contractor does not have to “loan” the homeowner money and hope to get reimbursed. The homeowner does not have to create an account or give a check or credit card number to the contractor or to the garden supply center. Purchase of the supplies may be made at the contractor's convenience.

### EXAMPLE 5

A college student needs money for books and rent. The student's parents create digital tokens for rent and for the bookstore for specific books and other needs of the student. The parents may email the digital tokens to the student. The student prints out the digital tokens. The printed tokens may then be provided by the student to the landlord, bookstore, etc. The vendors get their money and the student gets a place to live and books (but does not get the stereo). The parents are happy because the money is spent for its intended purpose (and not for the stereo desired by the student).

### EXAMPLE 6

Night out on the town. The user cannot decide which movie to go to. User creates tokens for two different movies (or one token with item code for “movie”). When the user arrives at the theater, he decides instead to go dancing. Unlike pre-purchased tickets, no money is lost due to the tokens if not used. If the user had gone to a movie, one scan of the token and the theater has the user's money and the user is admitted to the show.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented using hardware, software, or combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claim.

What is claimed is:

1. A method of generating a token, the method comprising:
receiving information identifying an account;
receiving information identifying an entity authorized to transfer value from the account; and
generating a token comprising token information, the token information comprising information identifying the account and information identifying the entity, wherein at least the information identifying the account is encrypted and the token enables value to be transferred from the account.

2. The method of claim 1 further comprising receiving information identifying an item or a class of items, and wherein the token information comprises information identifying the item or the class of items and the token enables value to be transferred from the account for a transaction involving the item or an item in the class of items.

3. The method of claim 1 further comprising receiving information identifying a vendor or a class of vendors, and wherein the token information comprises information identifying the vendor or the class of vendors and the token enables value to be transferred from the account to the vendor or to a vendor within the class of vendors.

4. The method of claim 1 wherein the token is an electronic token.

5. The method of claim 1 wherein the token is a physical token.

6. The method of claim 1 wherein a portion of the token information is encoded in machine readable information associated with the token.

7. The method of claim 1 further comprising receiving a value limit and wherein the token information comprises information identifying the value limit and the token enables transfer of value up to the value limit.

8. The method of claim 1 wherein generating the token comprises encrypting the information identifying the account using a public encryption key of the entity authorized to transfer value from the account.

9. The method of claim 1 wherein the entity authorized to transfer value from the account is an entity holding the account.

10. The method of claim 1 wherein the token enables monetary value to be transferred from a bank account.

11. The method of claim 1 further comprising providing the token to a first vendor in order to transfer value to the first vendor in a value-based transaction.

12. The method of claim 1 further comprising:
receiving authorization information; and
encrypting the authorization information;
wherein the token information comprises the encrypted authorization information.

13. A method of performing a transaction, the method comprising:
obtaining, at a vendor system of a vendor, token-related information from a token, the token-related information comprising information identifying an account and information identifying an entity authorized to transfer value from the account, wherein the information identifying the account is encrypted;
communicating the encrypted information identifying the account from the vendor system to the entity authorized to transfer value from the account;
communicating, from the vendor system to the entity, transaction information comprising information related to a transaction, the transaction information identifying a value to be transferred to the vendor; and
receiving, at the vendor system from the entity, a code indicating approval or rejection of transfer of the value to the vendor.

14. The method of claim 13 wherein the token-related information comprises information identifying an item or a class of items, the method further comprising:
communicating the information identifying the item or the class of items from the vendor system to the entity; and
wherein the transaction information communicated to the entity comprises information identifying an item involved in the transaction.

15. The method of claim 13 wherein the token-related information comprises information identifying a vendor or a class of vendors, the method further comprising:
communicating the information identifying the vendor or the class of vendors from the vendor system to the entity; and
wherein the transaction information communicated to the entity comprises information identifying the vendor.

16. The method of claim 13 wherein the token-related information comprises information identifying a value limit, the method further comprising communicating the value limit from the vendor system to the entity.

17. The method of claim 13 wherein obtaining the token-related information from the token comprises reading a machine readable code printed on the token.

18. The method of claim 13 wherein the account is a bank account, the method further comprising transferring the value from the account to the vendor.

19. The method of claim 13:
wherein the token-related information comprises information identifying an item or a class of items and information identifying a vendor or a class of vendors;
wherein the transaction information communicated to the entity comprises information identifying an item involved in the transaction and information identifying the vendor;
the method further comprising:
communicating the information identifying an item or a class of items and the information identifying a vendor or a class of vendors from the token-related information from the vendor system to the entity;
decrypting, at the entity, the encrypted information identifying the account;
determining if the vendor identified in the transaction information is same as the vendor identified in the token-related information or is a vendor that satisfies the class of vendors identified in the token-related information;
determining if the item identified in the transaction information is same as the item identified in the token-related information or is an item that satisfies the class of items identified in the token-related information;
approving transfer of the value identified in the transaction information from the account upon determining that the vendor identified in the transaction information is same as the vendor identified in the token-related information or is a vendor that satisfies the class of vendors identified in the token-related information and the item identified in the transaction information is same as the item identified in the token-related information or is an item that satisfies the class of vendors identified in the token-related information; and
transferring the value identified in the transaction information from the account to the vendor.

20. A system for generating a token, the system comprising:
a memory storing a plurality of instructions; and
a processor configured to execute the plurality of instructions, wherein upon execution of the plurality of instructions the processor is configured to:
receive information identifying an account; and
receive information identifying an entity authorized to transfer value from the account; and
cause generation of a token comprising token information, the token information comprising information identifying the account and information identifying the entity, wherein at least the information identifying the account is encrypted and the token enables value to be transferred from the account.

21. The system of claim 20 wherein the processor is configured to receive information identifying an item or a class of items, and wherein the token information comprises information identifying the item or the class of items and the token enables value to be transferred from the account for a transaction involving the item or an item in the class of items.

22. The system of claim 20 wherein the processor is configured to receive information identifying a vendor or a class of vendors, and wherein the token information comprises information identifying the vendor or the class of vendors and the token enables value to be transferred from the account to the vendor or to a vendor within the class of vendors.

23. The system of claim 20 wherein the token is an electronic token.

24. The system of claim 20 further comprising a printer configured to generate a physical token using a physical medium.

25. The system of claim 20 wherein the processor is configured to receive a value limit and wherein the token information comprises information identifying the value limit and the token enables transfer of value up to the value limit.

26. The system of claim 20 wherein:
a portion of the token information is encoded in machine readable information associated with the token; and
the processor is configured to encrypt the information identifying the account using a public encryption key of the entity authorized to transfer value from the account.

27. The system of claim 20 wherein the processor is configured to:
receive authorization information; and
encrypt the authorization information;
wherein the token information comprises the encrypted authorization information.

28. A system for performing a transaction, the system comprising:
a memory storing a plurality of instructions; and
a processor configured to execute the plurality of instructions, wherein upon execution of the plurality of instructions the processor is configured to:
obtain token-related information from a token, the token-related information comprising information identifying an account and information identifying an entity authorized to transfer value from the account, wherein the information identifying the account is encrypted;
communicate the encrypted information identifying the account to the entity authorized to transfer value from the account;
communicate, to the entity, transaction information comprising information related to a transaction, the transaction information identifying a value to be transferred to a vendor; and
receive, from the entity, a code indicating approval or rejection of transfer of the value to the vendor.

29. The system of claim 28 wherein the token-related information comprises information identifying an item or a class of items, and wherein the processor is configured to:
communicate the information identifying the item or the class of items to the entity;
wherein the transaction information communicated to the entity comprises information identifying an item involved in the transaction.

30. The system of claim 28 wherein the token-related information comprises information identifying a vendor or a class of vendors, and wherein the processor is configured to:
communicate the information identifying the vendor or the class of vendors to the entity; and
wherein the transaction information communicated to the entity comprises information identifying the vendor.

31. The system of claim 28 wherein the token-related information comprises information identifying a value limit, wherein the processor is configured to communicate the value limit to the entity.
